(19) United States
(12) Patent Application Publication
(10) Pub. No.: US 2025/0144734 A1
(43) Pub. Date: May 8, 2025

(54) TIG Rig Fitting Device

(71) Applicant: Luis Iracheta, Baytown, TX (US)

(72) Inventor: Luis Iracheta, Baytown, TX (US)

(21) Appl. No.: 18/760,584

(22) Filed: Jul. 1, 2024

Related U.S. Application Data
(60) Provisional application No. 63/595,985, filed on Nov. 3, 2023.

(51) Int. Cl. B23K 9/32

(52) U.S. Cl. CPC B23K 9/323

(57) ABSTRACT

A TIG rig fitting device is provided designed for use with a TIG rig, featuring a one-piece body made from materials like copper, brass, or aluminum, which are poor conductors of heat, thus preventing the device and the TIG rig from overheating. The body comprises a first end equipped with a wrench receiving member for secure handling with a wrench and threads for attachment to a TIG, alongside an opening with a round seal for gas flow into a TIG torch without leakage. The second end of the body includes a gas line connection member for attaching a gas line using a fastener, such as a pinch clamp, and another opening for a power cable, which can be secured inside the body with a fastener like a bolt or screw through a threaded fastener opening, facilitating efficient and safe operation during use.

### CROSS-REFERENCE TO RELATED APPLICATION

The present application claims priority to, and the benefit of, U.S. Provisional Application No. 63/595,985, which was filed on Nov. 3, 2023, and is incorporated herein by reference in its entirety.

### FIELD OF THE INVENTION

The present invention relates generally to the field of TIG welding. More specifically, the present invention relates to a heat-resistant device designed for use with TIG rigs, featuring a one-piece body made from poor heat conductors like copper, brass, or aluminum to prevent overheating. The body includes a first end with a wrench receiving member and threads for TIG torch, a gas flow opening with a seal, and a second end designed for gas line and power cable connections, ensuring secure and efficient operation. Accordingly, the present disclosure makes specific reference thereto. Nonetheless, it is to be appreciated that aspects of the present invention are also equally applicable to other like applications, devices, and methods of manufacture.

### BACKGROUND

TIG (Tungsten Inert Gas) welding is a precise and versatile welding method used in various applications that require high quality and precision. Existing TIG welding fittings are prone to overheating. This is undesirable as it increases the risk of burns or other injuries to welders. Moreover, the longevity of welding equipment is directly influenced by its ability to manage heat. Devices that overheat can suffer from accelerated wear and tear, necessitating frequent repairs or replacements of critical components, especially the torch. By ensuring a device remains cool, or efficiently dissipates heat, the lifespan of the equipment is extended, thereby offering cost savings over time.

The quality of the welds produced is another area where the impact of overheating can be detrimental. Excessive heat can lead to warping, distortions, or even adverse metallurgical changes in the materials being welded, compromising the structural integrity and appearance of the final product. A device that maintains a stable operating temperature is essential for achieving consistent, high-quality welds.

From the welder's perspective, the comfort and productivity during welding tasks are significantly enhanced by equipment that does not become overly hot. A cooler device allows for longer operating periods without the discomfort or potential hazards of handling hot equipment, thereby facilitating a more efficient and productive workflow.

Sensitive materials present additional challenges that are exacerbated by overheating. Certain metals and alloys may react unfavorably to excessive heat, leading to damage or undesirable changes in properties beyond the immediate weld area. A device that operates at lower temperatures helps in preserving the integrity of these materials.

Lastly, energy efficiency is a notable benefit of devices that avoid overheating. Such equipment indicates a more effective use of input power, directing the majority towards the welding process itself rather than losing energy as excess heat. This efficiency not only reduces operational costs but also contributes to a more environmentally friendly welding process by minimizing energy waste.

Therefore, there exists a long-felt need in the art for an improved TIG welding fitting. There also exists a long-felt need in the art for a TIG rig fitting device. More specifically, there exists a long-felt need in the art for a TIG rig fitting device that does not conduct a significant amount of heat during use.

The subject matter disclosed and claimed herein, in one embodiment thereof, comprises a TIG rig fitting device. The device is designed for use with a TIG rig, featuring a one-piece body made from materials like copper, brass, or aluminum, which are poor conductors of heat, thus preventing the device and the TIG rig from overheating. The body comprises a first end equipped with a wrench receiving member for secure handling with a wrench and threads for attachment to a TIG, alongside an opening with a round seal for gas flow into a TIG torch without leakage. The second end of the body includes a gas line connection member for attaching a gas line using a fastener, such as a pinch clamp, and another opening for a power cable, which can be secured inside the body with a fastener like a bolt or screw through a threaded fastener opening, facilitating efficient and safe operation during use.

In this manner, the TIG rig fitting device of the present invention accomplishes all the forgoing objectives and provides an improved TIG welding fitting. More specifically, the device provides a TIG rig fitting device that does not conduct heat. As a result, the device provides a welder with the benefits as described above.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a TIG rig fitting device comprised of a one-piece body. The body may be made from a plurality of materials such as but not limited to copper, brass, aluminum, etc. that is preferably a poor (and/or non) conductor of heat. During use, the device does not overheat and prevents a TIG rig from overheating.

The body is comprised of a first end comprised of at least one wrench receiving member comprised of a flat surface that allows a crescent wrench (or other similar wrench type) to grip the body to turn/secure the body during use. The first end is also comprised of at least one thread that allows the device to attach to a TIG. The first end is also comprised of at least one opening that allows gas to flow through the body and into a TIG torch.

The second end is comprised of at least one gas line connection member that extends from the body that allows a gas line to be connected to the body. The gas line may be secured to/around the member via at least one fastener such as but not limited to a pinch clamp. The second end is also comprised of at least one opening that allows a power cable to be fed into the body. The cable can then be secured within the body via inserting at least one fastener (such as but not limited to a bolt or a screw) into at least one threaded fastener opening.

The present invention is also comprised of a method of using the device. First, a device is provided comprised of at least one fastener, a body comprised of a first end comprised of at least one thread and at least one opening, and a second end comprised of at least one gas line connection, at least one opening, and at least one fastener opening. Then, a gas line can be connected to the gas line connection. Next, a power cable can be inserted into the opening and secured within the opening via placing a fastener into the opening. Finally, the first end can be attached to a TIG torch via the thread.

Accordingly, the TIG rig fitting device of the present invention is particularly advantageous as it is an improved TIG welding fitting. More specifically, the device provides a TIG rig fitting device that does not conduct heat. As a result, the device provides a welder with the benefits as described above and overcomes the limitations of existing TIG welding fittings known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a TIG rig fitting device of the present invention in accordance with the disclosed architecture;

FIG. 2 illustrates a perspective view of one potential embodiment of a TIG rig fitting device of the present invention in accordance with the disclosed architecture;

FIG. 3 illustrates a front view of one potential embodiment of a TIG rig fitting device of the present invention in accordance with the disclosed architecture;

FIG. 4 illustrates a rear view of one potential embodiment of a TIG rig fitting device of the present invention in accordance with the disclosed architecture;

FIG. 5 illustrates a perspective view of one potential embodiment of a TIG rig fitting device of the present invention while an electrical cable and a gas line is attached to the device in accordance with the disclosed architecture; and

FIG. 6 illustrates a flowchart of a method of using one potential embodiment of a TIG rig fitting device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved TIG welding fitting. There also exists a long-felt need in the art for a TIG rig fitting device. More specifically, there exists a long-felt need in the art for a TIG rig fitting device that does not conduct a significant amount of heat during use.

The present invention, in one exemplary embodiment, is comprised of a TIG rig fitting device comprised of a one-piece body. The body may be made from a plurality of materials such as but not limited to copper, brass, aluminum, etc. that is preferably a poor (and/or non) conductor of heat. During use, the device does not overheat and prevents a TIG rig from overheating.

The body is comprised of a first end. The first end is comprised of at least one wrench receiving member comprised of a flat surface that allows a crescent wrench (or other similar wrench type) to grip the body to turn/secure the body during use. The first end is also comprised of at least one thread that allows the device to attach to a TIG and at least one opening that allows gas to flow through the body and into a TIG torch.

The second end is comprised of at least one gas line connection member that extends from the body that allows a gas line to be connected to the body. The gas line may be secured to/around the member via at least one fastener such as but not limited to a pinch clamp. The second end is also comprised of at least one opening that allows a power cable to be fed into the body. The cable can then be secured within the body via inserting at least one fastener (such as but not limited to a bolt or a screw) into at least one threaded fastener opening.

The present invention is also comprised of a method of using the device. First, a device is provided comprised of at least one fastener, a body comprised of a first end comprised of at least one thread and at least one opening, and a second end comprised of at least one gas line connection, at least one opening, and at least one fastener opening. Then, a gas line can be connected to the gas line connection. Next, a power cable can be inserted into the opening and secured within the opening via placing a fastener into the opening. Finally, the first end can be attached to a TIG torch via the thread.

Accordingly, the TIG rig fitting device of the present invention is particularly advantageous as it is an improved TIG welding fitting. More specifically, the device provides a TIG rig fitting device that does not conduct heat. As a result, the device provides a welder with the benefits as described above and overcomes the limitations of existing TIG welding fittings known in the art.

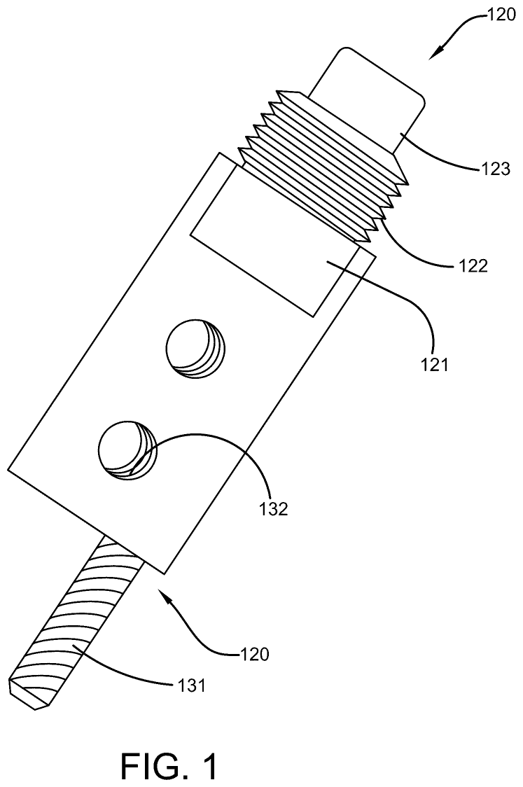

Referring initially to the drawings, FIG. 1 illustrates a perspective view of one potential embodiment of a TIG rig fitting device 100 of the present invention in accordance with the disclosed architecture. The device 100 is comprised of a one-piece body 110. The body 110 may be made from a plurality of materials such as but not limited to copper, brass, aluminum, etc. The body 110 material preferably is a poor (and/or non) conductor of heat. During use, the device 100 does not overheat and prevents a TIG rig from overheating.

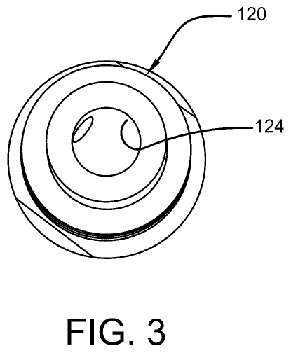

The body 110 is comprised of a first end 120. The first end 120 is comprised of at least one wrench receiving member 121. The member 121 is comprised of a flat surface that allows a crescent wrench (or other similar wrench type) to grip the body 110 to turn/secure the body 110 during use. The first end 120 is also comprised of at least one thread 122. The threads 122 allow the device 100 to attach to a TIG. The first end 120 is also comprised of at least one opening 124, as seen in FIG. 3., that allows gas to flow through the body 110 and into a TIG torch. The opening 124 may be comprised of at least one round seal 123 that prevents gas from escaping when the device 100 is attached to a TIG torch.

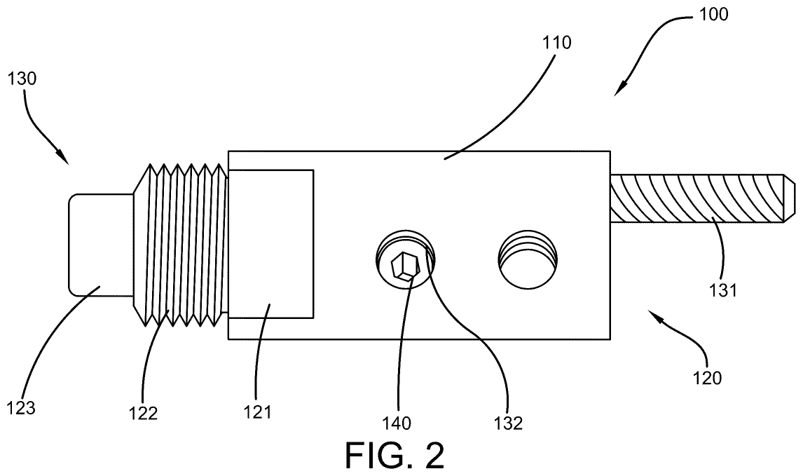

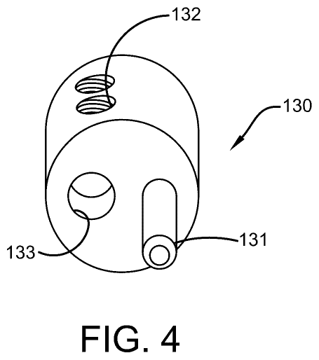

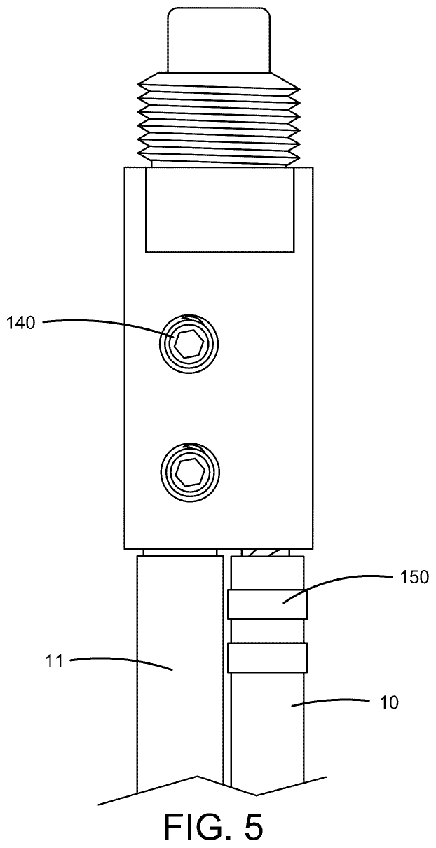

The second end 130 is comprised of at least one gas line connection member 131 (as seen in FIG. 2) that extends from the body 110 that allows a gas line 10 to be connected to the body 110. The gas line 10 may be secured to/around the member 131 via at least one fastener 150 such as but not limited to a pinch clamp. The second end 130 is also comprised of at least one opening 133 (as seen in FIG. 4) that allows a power cable 11 to be fed into the body 110. The cable 11 can then be secured within the body 110 via inserting at least one fastener 140 (such as but not limited to a bolt or a screw) into at least one threaded fastener opening 132, as seen in FIG. 5.

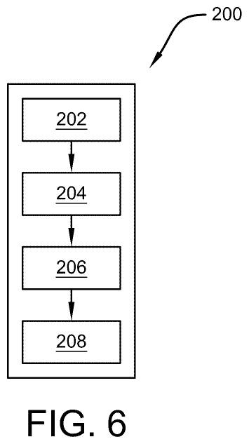

The present invention is also comprised of a method of using 200 the device 100, as seen in FIG. 6. First, a device 100 is provided comprised of at least one fastener 140, a body 110 comprised of a first end 120 comprised of at least one thread 122 and at least one opening 124, and a second end 130 comprised of at least one gas line connection 131, at least one opening 133, and at least one fastener opening 132 [Step 202]. Then, a gas line can be connected to the gas line connection 131 [Step 204]. Next, a power cable can be inserted into the opening 133 and secured within the opening 133 via placing a fastener 140 into the opening 133 [Step 206]. Finally, the first end 120 can be attached to a TIG torch via the thread 122 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “TIG rig fitting device” and “device” are interchangeable and refer to the TIG rig fitting device 100 of the present invention.

Notwithstanding the forgoing, the TIG rig fitting device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the TIG rig fitting device 100 as shown in the FIGS. are for illustrative purposes only, and that many other sizes and shapes of the TIG rig fitting device 100 are well within the scope of the present disclosure. Although the dimensions of the TIG rig fitting device 100 are important design parameters for user convenience, the TIG rig fitting device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A TIG rig fitting device comprising:
a body comprised of:
a first end comprised of a thread, a wrench receiving member, a seal, and a first opening; and
a second end comprised of a gas line connection, a fastener opening, and a second opening.

2. The TIG rig fitting device of claim 1, wherein the body is comprised of a copper, a brass, or an aluminum material.

3. The TIG rig fitting device of claim 1, wherein the wrench receiving member is comprised of a flat surface.

4. The TIG rig fitting device of claim 1, wherein the seal is comprised of a round seal.

5. The TIG rig fitting device of claim 1, wherein the fastener opening is comprised of a threaded opening.

6. The TIG rig fitting device of claim 5, wherein the TIG rig fitting device is comprised of a fastener.

7. The TIG rig fitting device of claim 6, wherein the fastener is comprised of a screw.

8. The TIG rig fitting device of claim 6, wherein the fastener is comprised of a bolt.

9. A TIG rig fitting device comprising:
a first fastener;
a body comprised of:
a first end comprised of a thread, a wrench receiving member, a seal, and a first opening; and
a second end comprised of a gas line connection, a fastener opening, and a second opening.

10. The TIG rig fitting device of claim 9, wherein the body is comprised of a copper, a brass, or an aluminum material.

11. The TIG rig fitting device of claim 9, wherein the wrench receiving member is comprised of a flat surface.

12. The TIG rig fitting device of claim 9, wherein the seal is comprised of a round seal.

13. The TIG rig fitting device of claim 9, wherein the fastener opening is comprised of a threaded opening.

14. The TIG rig fitting device of claim 13, wherein the TIG rig fitting device is comprised of a second fastener.

15. The TIG rig fitting device of claim 14, wherein the second fastener is comprised of a screw.

16. The TIG rig fitting device of claim 14, wherein the second fastener is comprised of a bolt.

17. The TIG rig fitting device of claim 9, wherein the first fastener is comprised of a pinch clamp.

18. A method of using a TIG rig fitting device, the method comprising the following steps:
providing a TIG rig fitting device comprised of a fastener, a body comprised of a first end comprised of a thread and first opening, and a second end comprised of a gas line connection, a second opening, and a fastener opening;
connecting a gas line to the gas line connection;
inserting a power cable into the second opening and placing a fastener into the fastener opening; and
attaching the first end to a TIG torch via the thread.

19. The method of using a TIG rig fitting device of claim 18, wherein the fastener opening is comprised of a threaded opening.

20. The method of using a TIG rig fitting device of claim 18, wherein the body is comprised of a copper, a brass, or an aluminum material.
